(19) United States
(12) Patent Application Publication
(10) Pub. No.: US 2012/0051807 A1
(43) Pub. Date: Mar. 1, 2012

(54) PRINTER HEATING ELEMENT

(75) Inventors: Tab A. Tress, Henrietta, NY (US); Robert S. Pawlik, Canandaigua, NY (US); Brian Gillis, Penfield, NY (US); Nathan E. Smith, Hamlin, NY (US)

(73) Assignee: XEROX CORPORATION, Norwalk, CT (US)

(21) Appl. No.: 12/869,795

(22) Filed: Aug. 27, 2010

(51) Int. Cl. G03G 15/20

(52) U.S. Cl. 399/328; 399/334

(57) ABSTRACT

An improved fuser includes a heater which provides uniformity at the surface of a fuser roll that contacts an imaged sheet. The heater is configured to include a single resistive element shaped to heat multiple sheet sizes with independently controllable conductive traces connected to outer segments of the resistive element and adapted to supply electricity to separate sections of the resistive element in accordance with the size of sheet being fed through the fuser center registered and without the need for cold spot compensation.

### BACKGROUND

1. Field of the Disclosure

This invention relates generally to electrostatographic reproduction machines, and more particularly, to a fuser adapted to handle multiple paper widths and is especially useful in center registered machines.

2. Description of Related Art

In electrostatographic printing, commonly known as xerographic or printing or copying, an important process step is known as “fusing”. In the fusing step of the xerographic process, dry marking making material, such as toner, which has been placed in imagewise fashion on an imaging substrate, such as a sheet of paper, is subjected to heat and/or pressure in order to melt the otherwise fuse the toner permanently on the substrate. In this way, durable, non-smudging images are rendered on the substrates.

The most common design of a fusing apparatus as used in commercial printers includes two rolls, typically called a fuser roll and a pressure roll, forming a nip therebetween for the passage of the substrate therethrough. Typically, the fuser roll further includes, disposed on the interior thereof, one or more heating elements, which radiate heat in response to a current being passed therethrough. The heat from the heating elements passes through the surface of the fuser roll, which in turn contacts the side of the substrate having the image to be fused, so that a combination of heat and pressure successfully fuses the image. As shown in U.S. Pat. No. 7,193,180 B2, for example, a resistive heater is disclosed that is adapted for heating a fuser belt with the heater comprising a substrate, a first resistive trace formed over the substrate, and a second resistive trace formed so as to at least partially overlap the first trace.

Provisions can be made in fusers to take into account the fact that sheets of different sizes may be passed through the fusing apparatus, ranging from postcard-sized sheets to sheets which extend the full length of the rolls. Further, it is known to control the heating element or elements inside the fuser roll to take into account the fact that a sheet of a particular size is being fed through the nip. For example, in U.S. Pat. No. 6,353,718 B1 a fuser roll is shown with two parallel lamps or heating elements therein that in each case include a relatively long major portion of heating-producing material along with a number of smaller portions of heat-producing material with all being connected in series. Within each lamp, a major portion is disposed toward one particular end of the fuser roll, while the relatively smaller portions are disposed toward the opposite end of the fuser roll. This particular configuration of heating elements within each lamp will have a relatively hot and relatively cold end. That is, when electrical power is applied to either lamp, one end of the lamp will largely generate more heat that the other end of the lamp.

U.S. Pat. No. 7,228,082 B1 discloses printing machine that includes a fuser for fusing an image onto a sheet. The fuser includes an endless belt having a plurality of predefined sized fusing areas that are selectively activatable and the plurality of predefined sized fusing areas are arranged in a substantially parallel manner along a process direction of the belt. A means is included for activating one or more of the plurality of predefined sized fusing areas to correspond to one of the selected predefined sized sheets. Multi-tap series controlled ceramic heaters of this design have a flaw in that a conductor interface to the heat-producing materials creates a cold spot which reduces the heater temperature locally and creates a radial cold area in the fuser roll causing image quality issues. The heretofore mentioned patents are included herein to the extent necessary to practice the present disclosure.

The problem that needs to be addressed is heater configuration supporting center registration substrates with simplistic TCO (Thermal Cut-Out) monitoring and elimination of CSC (Cold Spot Compensation). Prior art for contact heater elements use edge registration of the substrate to simplify resistive/conductive trace and contact design.

### BRIEF SUMMARY

Accordingly, the encompassed heater designs show two options, both of which require only one TCO to support monitoring requirements for abnormal temperatures. An improved fuser is disclosed that includes a heater which provides uniformity at the surface of the fuser that contacts an imaged sheet by configuring the heater to include a single resistive element shaped to heat multiple sheet sizes with independently controllable conductive traces connected to outer segments of the resistive element and adapted to supply electricity to separate sections of the resistive element in accordance with the size of sheet being fed through the fuser and without cold spot compensation. With this heater configuration only one thermal cut-off for safety purposes is required, thereby lowering the unit manufacturing cost and reducing the complexity of the fuser heater design.

The disclosed printer and fuser system may be operated by and controlled by appropriate operation of conventional control systems. It is well known and preferable to program and execute imaging, printing, paper handling, and other control functions and logic with software instructions for conventional or general purpose microprocessors, as taught by numerous prior patents and commercial products. Such programming or software may, of course, vary depending on the particular functions, software type, and microprocessor or other computer system utilized, but will be available to, or readily programmable without undue experimentation from, functional descriptions, such as, those provided herein, and/or prior knowledge of functions which are conventional, together with general knowledge in the software of computer arts. Alternatively, any disclosed control system or method may be implemented partially or fully in hardware, using standard logic circuits or single chip VLSI designs.

The term ‘printer’ or ‘reproduction apparatus’ as used herein broadly encompasses various printers, copiers or multifunction machines or systems, xerographic or otherwise, unless otherwise defined in a claim. The term ‘sheet’ herein refers to any flimsy physical sheet or paper, plastic, or other useable physical substrate for printing images thereon, whether precut or initially web fed. A compiled collated set of printed output sheets may be alternatively referred to as a document, booklet, or the like. It is also known to use interposers or inserters to add covers or other inserts to the compiled sets.

As to specific components of the subject apparatus or methods, or alternatives therefor, it will be appreciated that, as normally the case, some such components are known per se' in other apparatus or applications, which may be additionally or alternatively used herein, including those from art cited herein. For example, it will be appreciated by respective engineers and others that many of the particular components mountings, component actuations, or component drive systems illustrated herein are merely exemplary, and that the same novel motions and functions can be provided by many other known or readily available alternatives. All cited references, and their references, are incorporated by reference herein where appropriate for teachings of additional or alternative details, features, and/or technical background. What is well known to those skilled in the art need not be described herein.

### BRIEF DESCRIPTION OF THE DRAWINGS

Various of the above-mentioned and further features and advantages will be apparent to those skilled in the art from the specific apparatus and its operation or methods described in the example(s) below, and the claims. Thus, they will be better understood from this description of these specific embodiment(s), including the drawing figures (which are approximately to scale) wherein:

FIG. 1 is an elevational view showing relevant elements of an exemplary toner imaging electrostatographic machine including a first embodiment of the fusing apparatus of the present disclosure;

FIG. 2 is an enlarged schematic end view of the fusing apparatus of FIG. 1;

FIG. 3 is partial plan view of the heater portion of the first embodiment of the improved fuser of FIG. 2 that employs a segmented resistive trace connected to conductive traces and is independently controllable; and

FIG. 4 is a partial plan view of the heater portion of a second embodiment of an improved fuser that employs a single resistive trace which interfaces with multiple conductive traces in order to accommodate multiple sheet widths.

### DETAILED DESCRIPTION OF THE PREFERRED EMBODIMENT

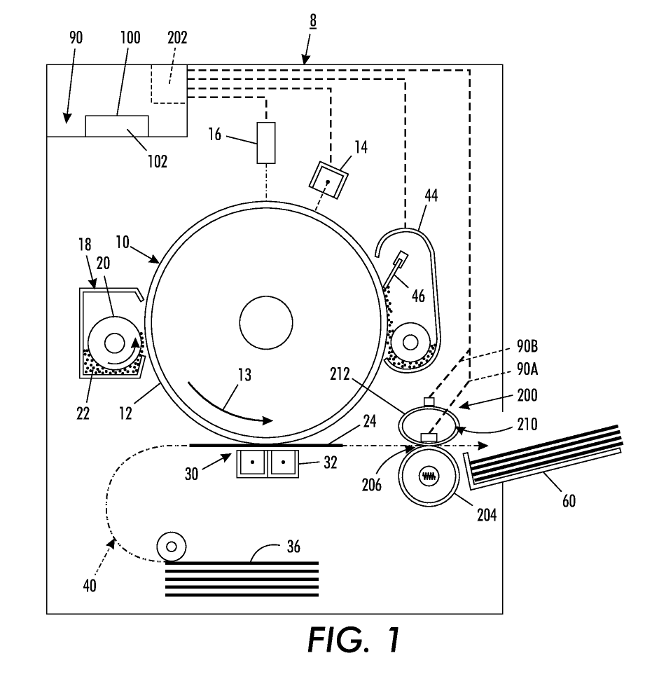

Referring now to FIG. 1, an electrostatographic or toner-imaging machine 8 is shown. As is well known, a charge receptor or photoreceptor 10 having an imageable surface 12 and rotatable in a direction 13 is uniformly charged by a charging device 14 and imagewise exposed by an exposure device 16 to form an electrostatic latent image on the surface 12. The latent image is thereafter developed by a development apparatus 18 that, for example, includes a developer roll 20 for applying a supply of charged toner particles 22 to such latent image. The developer roll 20 may be of any of various designs, such as, a magnetic brush roll or donor roll, as is familiar in the art. The charged toner particles 22 adhere to appropriately charged areas of the latent image. The surface of the photoreceptor 10 then moves, as shown by the arrow 13, to a transfer zone generally indicated as 30. Simultaneously, a print sheet 24 on which a desired image is to be printed is drawn from sheet supply stack 36 and conveyed along sheet path 40 to the transfer zone 30.

At the transfer zone 30, the print sheet 24 is brought into contact or at least proximity with a surface 12 of photoreceptor 10, which at this point is carrying toner particles thereon. A corotron or other charge source 32 at transfer zone 30 causes the toner image on photoreceptor 10 to be electrostatically transferred to the print sheet 24. The print sheet 24 is then forwarded to subsequent stations, as is familiar in the art, including the fusing station having a high precision-heating and fusing apparatus 200 of the present disclosure, and then to an output tray 60. Following such transfer of a toner image from the surface 12 to the print sheet 24, any residual toner particles remaining on the surface 12 are removed by a toner image baring surface cleaning apparatus 44 including a cleaning blade 46 for example.

As further shown, the reproduction machine 8 includes a controller or electronic control subsystem (ESS), indicated generally by reference numeral 90 which Is preferably a programmable, self-contained, dedicated mini-computer having a central processor unit (CPU), electronic storage 102, and a display or user interface (UI) 100. At UI 100, a user can select one of the pluralities of different predefined sized sheets to be printed onto. The conventional ESS 90, with the help of sensors, a look-up table 202 and connections, can read, capture, prepare and process image data such as pixel counts of toner images being produced and fused. As such, it is the main control system for components and other subsystems of machine 8 including the fusing apparatus 200 of the present disclosure.

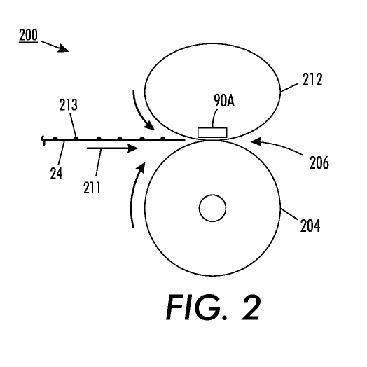

Referring now to FIG. 2, the fusing apparatus 200 of the present disclosure is illustrated in detail and is suitable for uniform and quality heating of unfused toner images 213 in the electrostatographic reproducing machine 8. As illustrated, fusing apparatus 200 includes a rotatable pressure member 204 that is mounted forming a fusing nip 206 with a highly conductive ceramic fuser roll member 210. Heater 90A is positioned in contact with the inner diameter of fuser roll belt 210. Heater 90B is optional as required by design configuration. A copy sheet 24 carrying an unfused toner image 213 thereon can thus be fed in the direction of arrow 211 through the fusing nip 206 for high quality fusing.

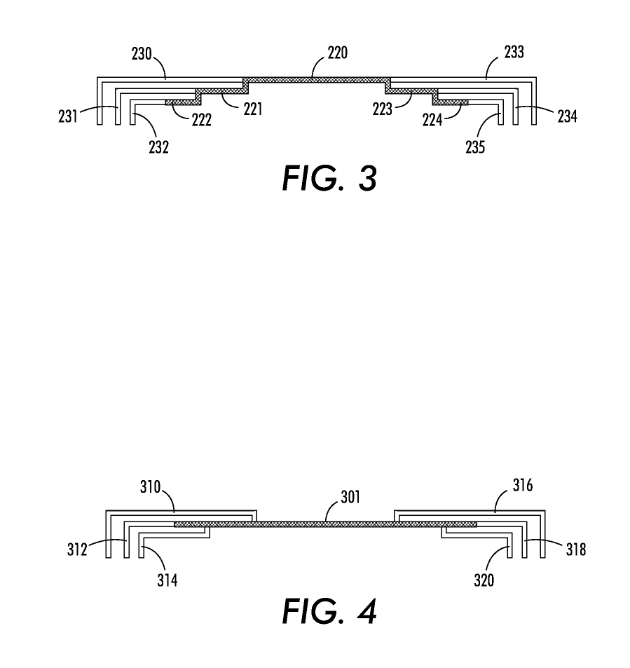

In FIGS. 3 and 4, improved heating element design configurations are disclosed in accordance with the present disclosure that are especially adapted for surface under rapid fusing (SURF) in a center registered office machine. These configurations use one or more conductive traces, in addition to the resistive heating traces, to strategically enable or disable areas of the cross-process width, depending on the paper size being used. By using these trace designs, the number of thermal cut-offs can be reduced to only one, thus lowering the unit manufacturing cost (UMC) and reducing the complexity of the fuser heater design.

A heater configuration is shown in FIG. 3 that uses a multiple trace design which provides system thermal control across all substrate widths and eliminates the requirement for CSC dependence. This configuration includes a single resistive element 220 bent so as to present two outer separate and parallel segments 221, 222, 223 and 224 that accommodate heating over individual sheet sizes. Six conductive traces 230, 231, 232, 233, 234 and 235 are connected at six contact points to the resistive segments and thereby facilitate independent control of the two outer segments 221, 222, 223 and 224. This configuration allows single or dual resistive paths. In addition, it allows for full temperature control across the fuser roll under various run and warm-up modes and provides for meeting safety standards through the use of a single thermal cut-out which provides lower UMC. This configuration eliminates any requirements of a cold spot compensation trace by providing energy inline with the conductive trace junction (low power sections of resistive trace) and thus is manufacturable with single trace resistive paths.

In FIG. 4, an alternative heater embodiment 300 is shown that provides a single trace design which reduces complexity of element design, but may continue to require CSC support depending on thermal conductivity of base a substrate. Included in this improved fuser hearer configuration is a single resistive element 301 contacted by conductive traces 310, 312, 314, 316, 318 and 320 that segment the resistive element 301 into two outer segments for heating sheets of different widths and contact the resistive element at six different locations. This configuration requires dual resistive paths and facilitates independent control of both outer segments. Cold spot compensation is negated by providing energy inline with conductive trace junctions. This configuration too allows for a single thermal cut-out.

Additionally, cold spot compensation requirements are reduced or eliminated in the heater configurations of FIGS. 3 and 4 through the use of higher thermally conductive ceramic substrates.

It should be understood that ceramic member 210 in FIG. 3 comprises a thermally conductive ceramic substrate layer 202, a friction coating layer (not shown), having a conductor/heater interface thereon; conductor traces 230, 231, 232, 233, 234 and 235; resistive trace 220 bent so as to present two outer separate and parallel segments 221, 222, 223 and 224; and a ceramic glazing electrical insulation layer (not shown). Power delivered at the conductor trace is delivered to the resistive trace causing it to heat up. The heat is then transferred through the thermally conductive ceramic substrate and the low friction coating layer to the fuser roll. The resistive trace is electrically isolated by the ceramic glazing.

In recapitulation, the embodiments of the present disclosure address a problem of cold spots on a segmented ceramic fuser heater at the point of contact between a resistive trace and a conductor trace. An electrical contact to the segments is needed within the image area and the prior heater designs exhibit a cold spot at that point due to cooling. The present disclosure solves this problem by providing energy inline with conductive junctions, and thus allow for full temperature control across the fuser roll while simultaneously meeting safety standards through the user of a single thermal cut-out.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A xerographic device adapted to print an image onto a copy sheet, comprising:
an imaging apparatus for processing and recording an image onto said copy sheet;
an image development apparatus for developing the image;
a transfer device for transferring the image onto said copy sheet; and
a fuser for fusing the image onto said copy sheet, said fuser including a fuser roll and a pressure roll that forms a nip therebetween through which said copy sheet is conveyed in order to permanently fuse the image onto said copy sheet, and wherein said fuser roll includes a heater comprising a single resistive trace bent so as to present two outer segments at predetermined widths to accommodate multiple copy sheet sizes, and wherein multiple conductive traces are connected at multiple contact points to said resistive trace and outer segments to facilitate independent control of said resistive trace and each of said outer segments.

2. The xerographic device of claim 1, including only one thermal cut-out.

3. The xerographic device of claim 2, wherein said multiple conductive traces comprise six conductive traces.

4. The xerographic device of claim 3, wherein said multiple contact points to said resistive trace and outer segments comprise six contact points.

5. The xerographic device of claim 4, wherein said resistive trace is configured to include three parallel segments.

6. The xerographic device of claim 1, including single resistive paths.

7. The xerographic device of claim 1, including dual resistive paths.

8. An electrophotographic printing machine including a fuser, said fuser comprising:
a pressure roll; and
a fuser roll that forms a nip therebetween through which a copy sheet is conveyed in order to permanently fuse an image onto said copy sheet, and wherein said fuser roll includes a heater having a single resistive trace configured so as to present two outer segments at predetermined widths to accommodate multiple copy sheet sizes, and wherein multiple conductive traces are connected at multiple contact points to said resistive trace and outer segments to facilitate independent control of said resistive trace and each of said outer segments.

9. The electrophotographic printing machine of claim 8, wherein said heater includes a single resistive trace.

10. The electrophotographic printing machine of claim 9, wherein said single resistive trace is configured to present there parallel segments.

11. The electrophotographic printing machine of claim 1, wherein said fuser roll is made of a highly conductive ceramic material.

12. The electrophotographic printing machine of claim 8, wherein said resistive and conductive traces are mounted on a highly conductive ceramic material.

13. The electrophotographic printing machine of claim 9, wherein said multiple conductive traces comprise six conductive traces.

14. The electrophotographic printing machine of claim 8, wherein said multiple contact points to said resistive trace and outer segments comprise six contact points.

15. A printing machine adapted to print an image on a copy sheet, comprising:
an imaging apparatus for processing and recording an image onto said copy sheets;
an image development apparatus for developing the image;
a transfer device for transferring the image onto said copy sheet; and
a fuser for fusing the image onto said copy sheet, said fuser including a fuser roll and a pressure roll that forms a nip therebetween through which a copy sheet is conveyed in order to permanently fuse said image onto said copy sheet, and wherein said fuser roll includes a heater having a single resistive trace, and wherein said single resistive trace is contacted at multiple points by multiple conductive traces which segment said resistive trace into two outer segments for heating copy sheets of different widths.

16. The printing machine of claim 15, wherein said resistive trace is contacted at six points by said multiple conductive traces.

17. The printing machine of claim 16, wherein cold spot compensation is negated by providing energy inline with said multiple conductive trace junctions.

18. The printing machine of claim 15, including dual resistive paths.

19. The printing machine of claim 18, wherein said at single resistive trace and said conductor traces are mounted on a ceramic substrate.

20. The printing machine of claim 15, including only one thermal cut-out.
